(19) United States
(12) Patent Application Publication
(10) Pub. No.: US 2011/0264672 A1
(43) Pub. Date: Oct. 27, 2011

(54) METHOD AND SYSTEM FOR DETECTING A SIMILARITY OF DOCUMENTS

(76) Inventors: Bela Gipp, Magdeburg (DE); Joeran Beel, Springe (DE)

(21) Appl. No.: 13/174,882

(22) Filed: Jul. 1, 2011

Related U.S. Application Data
(63) Continuation of application No. PCT/DE2009/000017, filed on Jan. 8, 2009.

(51) Int. Cl. G06F 17/30

(52) U.S. Cl. 707/749; 707/E17.008; 707/E17.108

(57) ABSTRACT

The invention relates to a method and a system for detecting a similarity of documents. The similarity of documents is detected with the help of an analysis of citations in one or more citation document(s), wherein the distance between the individual citations is used as criterion of the analysis. On the basis of the determined distance between two citations, respectively, a similarity value is determined, which is characteristic of the cited documents. A small distance between two citations leads to a high similarity of the cited documents. In case of several citations with regard to documents from several citation documents, the similarity values for the citation pairs from the individual citation documents are used for determining a final similarity value.

### CROSS REFERENCE TO RELATED APPLICATIONS

The present application is a continuation of International Application Number PCT/DE2009/000017 filed on Jan. 8, 2009, the entire contents of which are incorporated herein by reference.

### FIELD OF THE INVENTION

The present invention relates to a method and a system for detecting a similarity of documents. The invention particularly relates to a method and a system for detecting a similarity of documents, wherein similar documents are detected and possibly provided based on a predetermined document.

### STATE OF THE ART

Every year, millions of scientific publications are published as printed documents, electronic documents or as Internet pages. This makes it difficult to search for or find relevant publications concerning a certain subject area, since it is impossible to read all the publications.

Search engines are known, being specially adapted to the search for scientific publications. Search engines for scientific documents, such as Google Scholar by Google Inc., use two approaches in order to support the search for relevant publications, to be specific the word-based analysis of documents and the so-called citation analysis.

In case of the word-based analysis, the searching person enters one or more keyword(s), preferably of a subject area concerning the search to be performed. The underlying system detects one or more document(s) basing on the keywords. Preferentially, the system detects and proposes documents containing these keywords as often as possible. It is disadvantageous that the system also proposes documents, which are not thematically related to the searched subject area. In the worst case, irrelevant documents are wrongly classified as particularly relevant due to a preset sort sequence of the search engines, because the keywords are found particularly often in these documents. In addition to the automated search by means of the search engines, the searching person has to perform a manual filtering of the documents proposed by the search engine.

In case of the citation analysis, the searching person enters a document (input document), which is considered to be interesting or relevant for a certain subject area. On the basis of this input document, the search machine proposes documents which cite the input document (e.g. by means of references) or which are cited by the input document or the like. FIG. 1 illustrates the method of the citation analysis. In case the searching person considers the input document Input Doc to be relevant or interesting, the search engine could propose the following documents:
(1) documents which cite the input document Input Doc, i.e. the documents Doc A and Doc B;
(2) documents which are cited by the input document Input Doc, i.e. the documents Doc C and Doc D;
(3) documents which cite the same documents as the input document Input Doc, i.e. the document Doc BiboCo. This method is also known as bibliographic coupling;
(4) documents which are also cited by the documents detected according to (1) (Doc A and Doc B), i.e. the documents Doc CoCit 1 and Doc CoCit 2. This method is also known as co-citation analysis.

The citation analysis provides an initial indication that the cited documents or the citing documents might bear a certain reference with regard to the content, but it does not provide information on the degree of similarity of these documents to one another.

The present invention is based on the problem to provide a method and a device to be able to perform an enhanced search for similar documents.

### SUBJECT MATTER AND DEFINITION OF THE INVENTION

This problem is solved by a method with the features according to claim 1, a method with the features according to claim 15 as well as a system with the features according to claim 19.

Preferred embodiments of the invention are quoted in the following description as well as in the further claims.

According to this, a first aspect of the invention is to provide a method for detecting a similarity of documents, wherein the documents are at least once cited by at least one citing document, and wherein the method comprises at least the following steps:
detecting the positions of the citations with regard to the cited documents within the at least one citation document;
detecting a distance value between the positions of the citations within the at least one citation document;
calculating a similarity value (the so-called citation proximity index, CPI) for the documents, wherein the similarity value depends on the distance value between the two citations citing the documents, and wherein the similarity value indicates the similarity of the two documents to one another.

The degree of similarity (as similarity value CPI) is advantageously indicated in addition to a reference with regard to the content of the documents to one another, thus enabling a more differentiated search for similar documents. It particularly enables an enhanced computer-based similarity search.

According to a preferred embodiment of the invention, a smaller similarity value is calculated for a higher distance value. That is, the greater the distance between two citations within a citation document, the smaller the similarity or the similarity value of the cited documents and vice versa.

A value between a first limit value, i.e. a first threshold value and a second limit value i.e. a second threshold value can be calculated as similarity value CPI. The first limit value (or a value close to the first limit value) can indicate a low similarity and the second limit value (or a value close to the second limit value) can indicate a high similarity of the two documents and vice versa. The values 0 or 1 can be, for example, provided as limit values. These values are only exemplary. Other values can be provided.

In an embodiment, the distance can also be indicated ordinally scaled, such as “a=citations in the same sentence” or “b=citations in the same paragraph” etc.

The distance or the distance value between the citations within the citation document can be detected in different ways. According to a preferred embodiment of the invention, the distance value can be detected as follows:
with the help of the character distance (number of the characters between the citations);
with the help of the word distance (number of words between the citations);
with the help of the sentence distance (number of sentences between the citations);
with the help of the paragraphs (number of paragraphs between the citations or citations within the same paragraph);
with the help of the chapters (number of chapters between the citations or citations within the same chapter);
with the help of the pages (number of pages between the citations or citations within the same page); and/or
a combination thereof.

The distance value can also be given with the help of the distance of the citations, such as in cm or inch. The methods for detecting the distance proposed here are exemplary and not concluding. Further methods for detecting the distance between the citations can be provided and/or combined with methods mentioned before.

In a further preferred embodiment of the invention, several preliminary similarity values can be calculated in case of multiple citations of the documents within the citation document (i.e. when a citation with regard to a document occurs several times). The similarity value for the documents can be calculated from the preliminary similarity values. The individual preliminary similarity values can be determined from distances, which, in turn, have been determined by means of different methods. This method can also be used when the citation of the documents occurs within different citation documents, that is when two documents are cited by one first citation document and at least one more citation document.

The similarity value can be calculated by averaging the preliminary similarity values. A weighting of the preliminary similarity values can be performed when averaging said values.

In an embodiment of the invention, the respective highest preliminary similarity value can be used in order to determine the similarity value CPI.

In a further preferred embodiment of the invention, a significance factor can be determined, wherein the similarity value together with the significance factor indicate the similarity of the documents to one another. The significance factor can depend on the number of the most frequently found preliminary similarity values or on the number of the highest preliminary similarity values.

Preferentially, the method comprises a step for saving the similarity value for the documents on a memory device for finding and identifying similar documents, wherein the saving can comprise the following steps:
saving of the citation document and/or an identifier of the citation document;
saving of the (cited) documents and/or an identifier of the (cited) documents;
saving of the similarity value for the (cited) documents as well of the significance factor, if required; and
saving of the preliminary similarity values for the (cited) documents, wherein an additional relation to the respective citation document is saved for the preliminary similarity values.

The method can also comprise a step, in which the distance values are saved between two citations, respectively. This has the advantage that the method for calculating the similarity values can change without having to calculate the distance values again. Thus, a reanalysis (parsing) of the documents is avoided.

The saving of the preliminary similarity values has the advantage that an update operation, which may be required after having added a new document to the stock of documents, can be performed efficiently, since preliminary similarity values having been already calculated can be used.

A further aspect of the invention is to provide a method for finding and/or identifying at least one document being similar to a document, wherein a similarity value is determined for the documents, wherein the similarity value indicates the similarity of the documents to one another, wherein the similarity value for the documents is calculated depending on a distance value between the positions of citations with regard to the documents within at least one citation document, and wherein the method comprises at least the following steps:
accepting the document or a document identifier, for which similar documents are to be found and identified;
detecting documents for which a similarity value is determined or determinable with regard to the accepted document; and
outputting the detected documents.

The document identifier can be, for example, a unique document identifier or a combination of several attributes enabling the identification of a document, e.g. a combination of information such as the document's author(s), publication year, and title.

The detected documents can be output as a list of documents including, for example, document titles and authors. This list may also comprise a link for downloading the respective documents. However, the detected documents can also be output directly, i.e. they can be, for example, directly displayed on a display device. This is particularly advantageous if, for example, only very few similar documents are detected. There may also be a combined output, i.e. a list of similar documents, wherein the first document from the list (i.e. the most similar document) is directly displayed on a display device.

A further aspect of the invention is to provide a system for performing the method according to the present invention.

### BRIEF DESCRIPTION OF THE DRAWINGS

The invention is explained in detail with the help of the drawings. The drawings show:

FIG. 1 a method known from the state of the art for detecting similar documents;

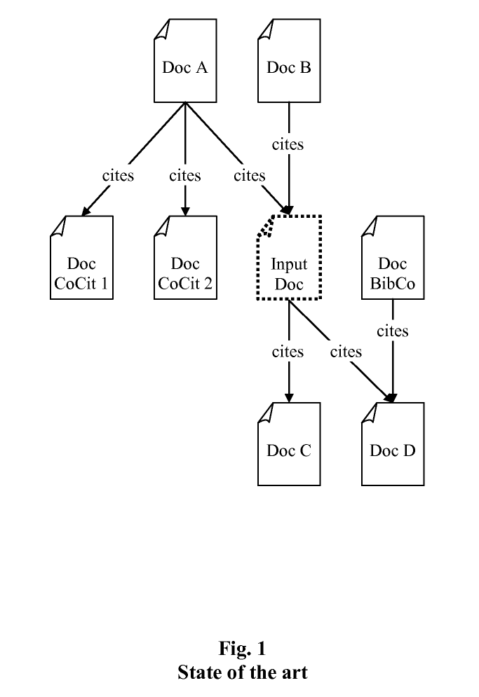

FIG. 2 an example for detecting similar documents by means of the method according to the present invention; and

FIG. 3 a flow chart of the method according to the present invention.

### DESCRIPTION OF A PREFERRED EMBODIMENT

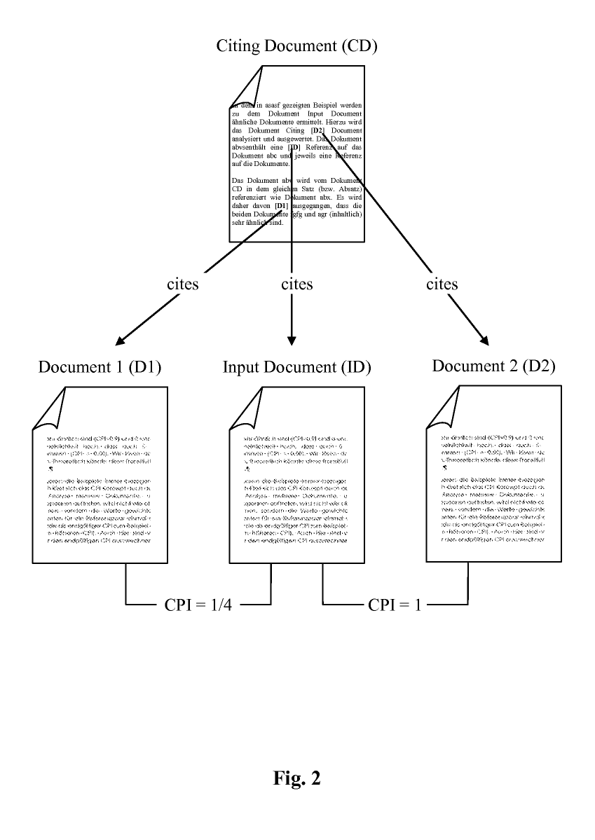

FIG. 2 shows an example which is used to explain a preferred embodiment of the invention.

The basic assumption of the present invention is that the closer two citations with regard to documents are found within one document, the more similar the cited documents are. Similarity can mean that the documents cover similar or the same subjects or they comprise similar or the same arguments. FIG. 2 illustrates this.

In the example shown in FIG. 2, similar documents are detected for the document Input Document (ID). For this, the document Citing Document (CD) is analyzed and evaluated. The document CD includes a citation with regard to the document ID and a citation with regard to the documents D1 and D2, respectively.

The document ID is cited by the document CD in the same sentence (or paragraph) as document D2. It is therefore assumed that the two documents ID and D2 are very similar (in content).

The document D1 is cited in the same document CD as the document ID, but only in a later paragraph. It is assumed that there is a certain similarity with regard to document ID, but that this similarity is lower than the similarity between the document ID and the document D2.

In order to detect the similarity of the documents ID, D1 and D2 cited in document CD, the distance of the citations within the document CD is determined pairwise. The example shown detects the distances between the citation pairs (ID, D1), (ID, D2) and (D1, D2).

Similarity values are calculated with the help of the determined distances, indicating the similarity between the respective cited documents.

There are different or consecutive possibilities to determine the distance between two citations. The following examples are designated to determine the distance between two citations. This list of examples is not concluding and other methods suitable for detecting the distances can also be used.

Examples for detecting the distance between two citations:
character distance (number of characters between two citations)
word distance (number of words between two citations)
sentence distance (number of sentences between two citations)
paragraph distance (number of paragraphs between two citations)
chapter or sub-chapter (number of chapters or sub-chapters between two citations)
page (number of pages between two citations)
table or table elements (number of the table elements (columns and/or rows) between two citations)
absolute distance, for example in cm, mm, inch etc., between two citations

In case of the examples paragraph, chapter/sub-chapter, page and table, the value 0 can be assumed as distance when the citations are in the same paragraph, chapter/sub-chapter, page or table. In these cases, it is possible to use the alternatives character distance, word distance or sentence distance in order to improve the determination of the distance. The combination of these variants makes it, for example, possible to at first determine the distances between the citations only with the help of the paragraphs between two citations and to only use the method word distance for such citation with the citations being in the same paragraph.

After having determined the distances, a distance value is available for each citation pair (ID, D1), (ID, D2) and (D1, D2). The similarity values are then calculated from the distance values.

Depending on the distance or the distance value between two citations, a similarity value is calculated for the citation pairs. The similarity value is called citation proximity index (CPI). If two citations are directly next to one another (e.g. word distance=0), the similarity value can be, for example, determined to be 1, which would mean that there is a very high similarity with regard to the two cited documents. However, if there are several paragraphs between two citations or if the citations are in consecutive paragraphs, as the citations with regard to the documents D1 and ID in FIG. 2, a lower value can be determined as similarity value, which would mean there is an existing but low similarity of the cited documents. The determination of the similarity values is simple in this example. The similarity values can also be determined according to more complex algorithms.

Examples of similarity values CPI on the basis of different distances:

| Distance | CPI |
|---|---|
| Two citations directly next to one another (character/word | 1.00 |
| distance = 0) | |
| Two citations in the same sentence | 0.90 |
| Two citations in two consecutive sentences | 0.85 |
| Two citations in the same paragraph | 0.75 |
| Two citations in two consecutive paragraphs | 0.60 |
| Two citations in the same chapter | 0.50 |
| Two citations in the same article | 0.25 |
| Two citations in the same book/conference/journal | 0.05 |

In the example shown in FIG. 2, a CPI of 1.0 is determined for the document pair (ID, D2), since the citations are directly next to one another (word distance=0). A CPI of 0.25 is determined for the document pair, since the citations are in different chapters or paragraphs.

The similarity value can be determined hierarchically, as already mentioned above. If two citations are, for example, in different paragraphs, the exact word distance between the citations may be disregarded. This will be illustrated with the help of the following excerpt:

“[ . . . ] Some studies show that boys are better in mathematics than girls [1], [2]. Other scientists counter that the results may be in accordance with the facts, but this would be due to the prejudiced education of the children and not due to possible genetic differences [3], [4].

[ . . . ]

In his paper [5] John Doe brings up another interesting subject. [ . . . ]”

It becomes clear that the cited documents [1] and [2] must be virtually identical in content with regard to the subject as well as to the statement regarding this subject. The same applies to documents [3] and [4]. It is also clear that the documents [1] and [2] and the documents [3] and [4] bear a high similarity to one another; they deal with the same subject, but with different arguments. Although the document [5] is closer to the documents [3] and [4] than to the documents [1] and [2] with regard to the words counted (word distance), it does not bear more resemblance with the documents [3] and [4] than with the documents [1] and [2], since the citation [5] is in a new paragraph.

In this example, the resulting similarity values would be:

| | | |
|---|---|---|
| CPI (1, 2) = 1 | CPI (1, 3) = 0.75 | CPI (1, 5) = 0.50 |
| CPI (3, 4) = 1 | CPI (1, 4) = 0.75 | CPI (2, 5) = 0.50 |
| | CPI (2, 3) = 0.75 | CPI (3, 5) = 0.50 |
| | CPI (2, 4) = 0.75 | CPI (4, 5) = 0.50 |

As an alternative, the similarity values can also be determined in different ways, which will be shown with the help of the following example:

“Author A shows in [1] that boys are better in mathematics than girls. His experiments have been performed with the help of persons aged 18 to 25. [ . . . ]

He ascribes his results to the fact that [ . . . ]

However, author A also acknowledges that [ . . . ]

Author B shares author A's view [2]. In addition to that, author B, however, found out that [ . . . ]”

There are no citations in paragraphs two and three. Therefore, the paragraphs may be disregarded assuming that the text after a citation always refers to the citation until a new citation is mentioned. The citations [1] and [2] would have a similarity value CPI for “citations in two consecutive paragraphs” of 0.60 according to the list above.

The preceding examples only determined the similarity values of individual citation pairs. However, citations may also appear repeatedly in a text. In this case, the determination of the similarity value is explained with the help of an extension of the example mentioned above:

“[ . . . ] Some studies show that boys are better in mathematics than girls [1], [2]. Other scientists counter that the results may be in accordance with the facts, but this would be due to the prejudiced education of the children and not due to possible genetic differences [3], [4].

[ . . . ]

In his paper [5] John Doe brings up another interesting subject. On the basis of an idea according to [3], he examined whether [ . . . ]”

In this example, citation [3] is mentioned again, which enables further possibilities of combination or citation pairs. Disregarding the first occurrence of citation [3] at first would result in the following modified similarity values CPI:

### CPI (3,1)=0.50

### CPI (3,2)=0.50

### CPI (3,4)=0.50

### CPI (3,5)=0.90

Taking into account also the first occurrence of the citation [3], this results in additional similarity values, which have already been listed before with regard to this example. One way of determining the similarity value is to always use the respective largest similarity value of a citation pair. However, it may also make sense to perform a weighting.

The following becomes apparent from the last example: if the citations [3] and [5] are very similar (CPI=0.9) and the citations [3] and [4] are also very similar (CPI=1), there is a high probability that also the citations [5] and [4] are more similar than originally assumed (CPI=0.50). This problem is solved by determining the similarity value as mean value of both similarity values or by weighting the individual similarity values. This means that preliminary similarity values for the citation pairs are determined first, which are then used to determine the actual similarity value relevant for the detection of the similarity. This transitivity can be continued across unlimited numbers of levels.

The above examples always considered citations with regard to documents within one single document and then determined the similarity value for the cited documents.

The concept of calculation according to the present invention also applies to several documents citing documents, when two or more documents are cited from two or more documents. For example, the documents D1 and ID from FIG. 2 may be cited in another document CD2 (not shown here) apart from document CD.

In case of the analysis of several documents, different similarity values CPI can be determined for a citation pair, e.g. for the citation pair (D1, ID), since the citations in a first citation document CD are within the same paragraph, whereas the citations in a second citation document are in different paragraphs.

For this, the highest similarity value determined can be used to determine the actual similarity value for the two documents.

As an alternative, the highest similarity value will not simply be used for the citation pair in order to detect the similarity of the documents, but the similarity values are weighted in order to form a similarity value that way.

For example, the analysis of three citation documents for a citation pair may once lead to a similarity value of 1 and twice to a similarity value of 0.25. The final similarity value could be assumed to be 0.95, i.e. the similarity value of 1 is weighted more strongly than the smaller similarity values. Again, numerous other calculation methods can be used to determine the final similarity value.

In addition to the similarity values, a so-called significance factor can be introduced. This way it is possible to further enhance the information value with regard to the similarity of documents for different citation pairs with the same similarity value. When a first citation pair obtains a similarity value of 1 on the basis of one document and a second citation pair obtains a similarity value of 1 on the basis of five documents, respectively, the high similarity of the documents with regard to the second citation pair is more probable than with regard to the first citation pair. The number of the highest similarity values can be used as significance factor for a citation pair. In case the five similarity values 1.0, 1.0, 0.50, 0.25 and 0.25 are determined for a citation pair, the final similarity value could, for example, be 0.93 with a significance factor of 2, since the highest individual similarity value of 1.0 for the citation pair occurs twice.

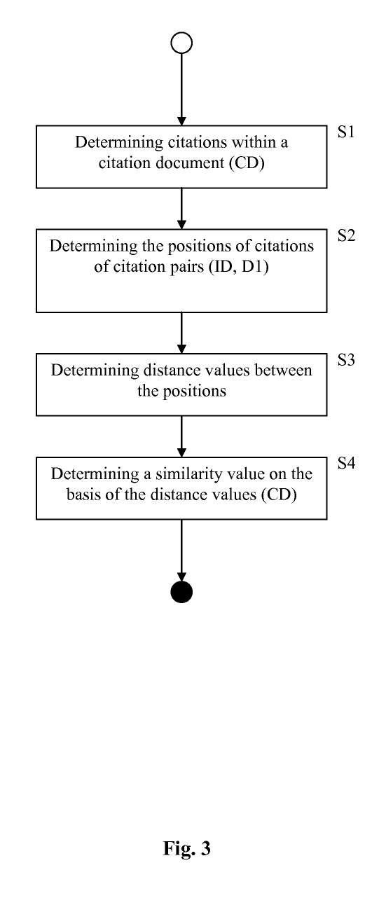

FIG. 3 shows the main steps of the method according to the present invention in a simplified flow chart. In a first step S1, the citations with regard to other documents are determined within one citation document. The citation document as well as the cited documents may be electronic documents or so-called web documents. The method described before also applies to web pages.

After having determined the citations within a citation document, citation pairs are formed in a second step S2. In a third step S3, the distance values between the citations of the citation pairs are determined with the help of the positions of the citations of a citation pair. The determination of the distance values is performed as already explained before with reference to FIG. 2.

In a final step S4, the similarity values are determined for each citation pair on the basis of the respective distance values. Step S4 may also comprise the variations for determining the similarity values described before with reference to FIG. 2, e.g. in case a citation pair occurs several times within a citation document or a citation pair occurs in several citation documents.

In an embodiment according to the invention, the citation documents and the cited documents are saved in a memory device. The cited documents may, in turn, serve as citation documents. The memory device, such as a data base, may also be provided to save the similarity values for the individual citation pairs.

In case a similarity value is determined from several preliminary similarity values (for example, in case a citation pair occurs several times within a citation document or in different citation documents), the preliminary similarity values can also be saved in the memory device for the respective citation pair. This has the advantage that not all the preliminary similarity values for a citation pair have to be determined again in case a citation document is newly added to the collection of documents.

As an alternative, the similarity values can be directly determined as reaction to a query. This is particularly suitable when only a small number of documents are involved.

According to the method, a searching person can predefine a document DI, for which the similar documents are to be detected. A processing device accepts the document DI (or an identifier of the document DI) and determines all the corresponding citation pairs. In case of the example shown in FIG. 2, the processing device would detect the documents D1 and D2 (wherein the citation pairs (DI, D1) and (D1, D2) have been detected). The similarity values 0.25 or 1.0 have been detected for the two citation pairs (DI, D1) and (D1, D2) and have been saved in the memory device. With the help of these similarity values, the processing device can sort the detected documents D1 and D2 according to the similarity and make them available as a sorted list to the searching person. In this example, the sort sequence would be D2, D1.

The underlying system, such as a computer or a computer network with connected memory device, may comprise an interface in order to also accept and process queries from the Internet for similar documents with regard to a citation document.

The block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain or store the program for use by or in connection with the instruction execution system, apparatus, or device.

The medium is tangible, and it can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described to best explain the principles of the invention, the practical application, and to enable others of ordinary skill in the art to understand the invention for various embodiments with various modifications as are suited to the particular use contemplated.

We claim:

1. A computer-implemented method for determining a similarity of documents (ID, D1), wherein the documents (ID, D1) are at least once cited by at least one citation document (CD), and wherein the method comprises at least the following steps:
determining the positions of the citations with regard to the documents (ID, D1) within the at least one citation document (CD);
determining a distance value between the positions of the citations within the at least one citation document (CD);
calculating a similarity value (CPI) for the documents (ID, D1), wherein the similarity value (CPI) depends on the distance value between the two citations citing the documents (ID, D1), and wherein the similarity value (CPI) indicates the similarity of the two documents (ID, D1) to one another.

2. A method according to claim 1, wherein different similarity values (CPI) are calculated for different distance values.

3. A method according to claim 1, wherein a value between a first limit value and a second limit value is calculated as similarity value (CPI), and wherein the first limit value indicates a low similarity and the second limit value indicates a high similarity of the two documents (ID, D1) and vice versa.

4. A method according to claim 1, wherein the determining of the distance value comprises at least one of determining the character distance, determining the word distance, determining the sentence distance, determining the paragraphs, determining the chapters, determining the pages and a combination thereof between the positions of the citations.

5. A method according to claim 1, wherein in case of multiple citations of the documents (ID, D1) within the citation document (CD) several preliminary similarity values (vCPI) are calculated, and wherein the similarity value (CPI) for the documents (ID, D1) is calculated from the preliminary similarity values (vCPI).

6. A method according to claim 5, wherein the similarity value (CPI) is calculated by averaging the preliminary similarity values (vCPI).

7. A method according to claim 1, wherein in case of a citation of the documents (ID, D1) within different citation documents (CD) several preliminary similarity values (vCPI) are calculated, and wherein the similarity value (CPI) for the documents (ID, D1) is calculated from the preliminary similarity values (vCPI).

8. A method according to claim 7, wherein the similarity value (CPI) is calculated by averaging the preliminary similarity values (vCPI).

9. A method according to claim 6, wherein a weighting of the preliminary similarity values (vCPI) is performed when averaging.

10. A method according to claim 1, wherein in case of several preliminary similarity values (vCPI) the method comprises a step for calculating a significance factor, and wherein the similarity value (CPI) together with the significance factor indicate the similarity of the two documents (ID, D1) to one another.

11. A method according to claim 10, wherein the significance factor depends on the number of the most frequently found preliminary similarity values (vCPI) or on the number of the highest preliminary similarity values (vCPI).

12. A method according to claim 1, wherein the method comprises a step for saving the similarity value (CPI) for the documents (ID, D1) on a memory device for finding and/or identifying similar documents.

13. A method according to claim 12, wherein the saving comprises at least:
saving of the citation document (CD) and/or an identifier of the citation document (CD);
saving of the documents (ID, D1) and/or an identifier of the documents (ID, D1);
saving of the similarity value (CPI) for the documents (ID, D1); and
saving of the preliminary similarity values (vCPI) for the documents (ID, D1), wherein an additional relation to the respective citation document (CD) is saved for the preliminary similarity values (vCPI).

14. A method according to claim 13, wherein the saving further comprises:
saving of the distance values between the positions of the citations within the citation document (CD).

15. A computer-implemented method for finding and identifying at least one first document (D1) being similar to a second document (ID), wherein a similarity value (CPI) is determined for the second document (ID) and the first document (D1), wherein the similarity value (CPI) indicates the similarity of the first document (D1) to the second document (ID), wherein the similarity value (CPI) for the documents (ID, D1) is calculated depending on a distance value between the positions of the citations with regard to the documents (ID, D1) within at least one citation document (CD), and wherein the method comprises at least the following steps:
receiving the second document (ID) or a document identifier, for which similar documents are to be found and/or identified;
determining first documents (D1) for which a similarity value (CPI) to the second document (ID) or to the document identifier is determined or determinable; and
outputting the detected first documents (D1).

16. A method according to claim 15, wherein the output order of the documents depends on the similarity values (CPI).

17. A method according to claim 15, wherein the similarity values (CPI) are determined after having received the second document (ID) or the document identifier.

18. A method according to claim 15, wherein the similarity values (CPI) have been saved in a memory device before having received the second document (ID) or the document identifier, and the similarity values (CPI) for finding and identifying are determined by query to the memory device.

19. A system for detecting a similarity (CPI) of documents (ID, D1), wherein the documents (ID, D1) are at least once cited by at least one citation document (CD), comprising:
at least one memory device for saving the documents (ID, D1) and/or an identifier of the documents (ID, D1);
a processing device being coupled with the memory device and being configured for
determining the positions of the citations with regard to the documents (ID, D1) within the at least one citation document (CD);
determining a distance value between the positions of the citations within the at least one citation document (CD);
calculating a similarity value (CPI) for the documents (ID, D1), wherein the similarity value (CPI) depends on the distance value between the two citations citing the documents (ID, D1), and wherein the similarity value (CPI) indicates the similarity of the two documents (ID, D1) to one another.

20. A system according to claim 19, comprising at least one interface in order to accept queries for similar documents with regard to a predetermined document via a LAN and/or a WAN, particularly the Internet or the World Wide Web, and to provide similar documents with regard to the predetermined document, wherein the interface is coupled with the processing device.

21. A system according to claim 19, wherein the processing device is further configured to determine documents, for which a similarity value (CPI) is saved with regard to a predetermined document (ID).

22. A data carrier product comprising a saved program code, being able to be loaded into a computer and/or into a computer network and being configured to perform the method of claim 1.
